(19) United States
(12) Patent Application Publication
(10) Pub. No.: US 2004/0071859 A1
(43) Pub. Date: Apr. 15, 2004

(54) Chicken cutting process

(76) Inventors: Johnny Appling, Flowery Branch, GA (US); Larry W. Miller, Braselton, GA (US)

Correspondence Address: WINSTON & STRAWN, PATENT DEPARTMENT, 1400 L STREET, N.W., WASHINGTON, DC, 20005-3502, US

(21) Appl. No.: 10/680,168

(22) Filed: Oct. 8, 2003

Related U.S. Application Data
(60) Provisional application No. 60/417,662, filed on Oct. 11, 2002.

(51) Int. Cl. A23L 1/315

(52) U.S. Cl. 426/644

(57) ABSTRACT

The invention relates to a method of making a cooked meat product which is more desirable to eat than conventionally prepared cooked meat products. The cooked meat products are made by methods that include portioning meat to a selected dimension and thickness to form a raw product which corresponds to a desired serving size; placing a plurality of spaced cuts through the thickness of the raw meat product and extending from a center portion of the raw meat product to its periphery to form a plurality of extensions; applying to the raw product a coating material comprising flour to form a coated raw product; and cooking the coated raw product to form a cooked meat product having a plurality of cooked strips corresponding to the extensions. The extensions can extend generally radially from the central portion or generally parallelly from one or both sides of the center portion. The cuts that are made in the raw meat product can be in the form of essentially straight lines or as curved cuts.

### CROSS-REFERENCE TO RELATED APPLICATIONS

This application claims the benefit of U.S. provisional application No. 60/417,662 filed Oct. 11, 2002.

### FIELD OF THE INVENTION

The present invention relates to a method of making a cooked food product and, more particularly, to a novel fried chicken product which includes a central portion and a plurality of elongated strips of edible material extending from the central portion in various arrangements.

### BACKGROUND OF THE INVENTION

Poultry is conventionally eviscerated and dressed and sold either as a whole or as parts. One of these parts is the breast cut, which is marketed with the bone therein or as a boneless breast cut. In view of the increasing demand for such new, innovative products as boneless breasts, tenders, wings, etc., for both the commercial food market and for home use, methods for easily obtaining different types of cuts have become increasingly more desirable. However, the prior art methods of producing dressed cuts of poultry have not been directed to a breast cut which has been dressed to permit the consumer to conveniently break down the breast cut into finger food.

U.S. Pat. Nos. 5,346,711 and 6,428,838 are directed to methods of dressing an edible material, such as a breast cut of poultry, such that the material has a core area and a plurality of strips of material formed integrally with the core area and extending outwardly therefrom in a random manner. The '711 patent is preferably directed to boneless breast meat while the '838 patent is directed to thigh meat that is still attached to the bone.

While the products prepared by these methods are useful because they are both appetizing and convenient for the consumer to handle, additional improvements are desired, and these are provided by the present invention.

### SUMMARY OF THE INVENTION

The invention relates to a method of making a cooked meat product which is more desirable to eat than conventionally prepared cooked meat products. There are a number of different embodiments for achieving these cooked meat products.

A first method comprises portioning meat to a selected dimension and thickness to form a raw product which corresponds to a desired serving size; placing a plurality of spaced cuts through the thickness of the raw meat product and extending from a center portion of the raw meat product to its periphery to form a star-shaped raw meat product having a plurality of extensions; applying to the raw product a coating material comprising flour to form a coated raw product; and cooking the coated raw product to form a cooked meat product having a plurality of cooked strips corresponding to the extensions.

In this embodiment, the cuts that are made in the raw meat product can be in the form of essentially straight lines to form radially-directed extensions or as curved cuts to form crescent-shaped extensions. If desired, the thickness of the raw meat product is cut essentially perpendicularly to the spaced cuts to create thinner extensions. When the final product is made, the cooked strips extend from the center portion in substantially the same plane.

Another method comprises portioning meat to a selected dimension and thickness to form a raw meat product that includes a center portion that connects at least one upper portion and at least two lower portions that are not joined, with the raw meat product corresponding to a desired serving size; placing a plurality of spaced cuts through the thickness of the upper and lower portions extending from the center portion of the raw meat product to its periphery to form a plurality of extensions; applying to the raw product a coating material comprising flour to form a coated raw product; and cooking the coated raw product to form a cooked meat product having a plurality of cooked strips corresponding to the extensions.

In this embodiment, the thickness of one or more of the upper and lower portions is cut essentially perpendicularly to the spaced cuts to create thinner extensions. Preferably, the thicknesses of all of the upper and lower portions are cut essentially perpendicularly to the spaced cuts to create thinner extensions. The spaced cuts are essentially perpendicular, but the cooked extensions extending from the center portion are not in the same plane.

Yet another method comprises portioning meat to a selected dimension and thickness to form a raw product which has upper center and lower portions and which corresponds to a desired serving size; placing a plurality of spaced cuts through the thickness of one of the lower or upper portions of the raw meat product extending from a center portion of the raw meat product to its upper or lower end to form a plurality of extensions; applying to the raw product a coating material comprising flour to form a coated raw product; and cooking the coated raw product to form a cooked meat product having a plurality of cooked strips corresponding to the extensions only in the lower or upper portion.

In this embodiment, the thickness of the center portion and the portion that includes the spaced cuts is cut essentially perpendicularly to the spaced cuts to create two central portions and thinner extensions. Preferably, the spaced cuts are essentially perpendicular, and the cooked extensions extend from the center portion but not in substantially the same plane.

In each embodiment, the meat is chicken and the raw product is a boneless single or butterflied chicken breast. Also, the coated raw product is preferably fried in oil to form a fried chicken product.

### BRIEF DESCRIPTION OF THE DRAWINGS

The foregoing summary, as well as the following detailed description of the presently preferred embodiments of the invention, will be better understood when read in conjunction with the appended drawing figures, wherein:

FIG. A1 is a top perspective view of an undressed chicken breast which has been apportioned prior to cutting according to one method of the present invention;

FIG. A2 is a top perspective view of the determination of the central portion of the breast;

FIG. A3 is a top perspective view of the breast which illustrates an indentation that indicates the central portion;

FIG. A4 illustrates the initial curved cuts made from the central portion to the periphery of the breast in accordance with the method of the present invention;

FIG. A5 illustrates additional curved cuts made from the central portion to the periphery of the breast;

FIG. A6 is a top perspective view of the final crescent cut raw chicken breast;

FIG. A7 is a top perspective view of the final fried crescent chicken breast of the invention;

FIG. B1 is a top perspective view of an undressed butterflied chicken breast which has been apportioned prior to cutting according to another method of the present invention;

FIG. B2 is a top perspective view of breast of FIG. B1 with an indication of where the lower breast portions should be cut and split into upper and lower halves;

FIG. B3 illustrates the initial cutting to split the thicknesses of the lower breast portions;

FIG. B4 illustrates the further cutting of lower portions to provide elongated strips;

FIG. B5 is a top perspective view of the determination of the central portion of the butterflied breast;

FIGS. B6 and B8 illustrates the cutting of the thicknesses of the upper breast portions;

FIGS. B7 and B9 illustrate the further cutting of upper portions of the breast to provide elongated strips;

FIG. B10 is a top perspective view of the final crescent cut raw butterflied chicken breast;

FIG. B11 is a top perspective view of the flour coating on the crescent cut raw butterflied chicken breast;

FIG. B12 is an illustration of the immersion of the flour coated raw chicken product of FIG. B11 into hot oil;

FIG. B13 is a perspective view of the final fried butterflied chicken breast of the invention;

FIG. C1 is a top perspective view of an undressed chicken breast which has been apportioned prior to cutting according to yet another method of the present invention;

FIG. C2 illustrates the initial cutting to split the thickness of the lower breast portion;

FIG. C3 and C4 illustrate the further cutting of lower portions to provide elongated strips;

FIG. C5 is a top perspective view of the final cut raw “calamari” chicken breast;

FIG. C6 illustrates the separation of the fingers prior to coating with flour;

FIG. C7 is a top perspective view of the flour coating on the cut raw chicken breast;

FIG. C8 is an illustration of the immersion of the flour coated raw chicken product of FIG. C7 into hot oil; and

FIG. C9 is a perspective view of the final fried chicken breast of the invention;

### DETAILED DESCRIPTION OF THE PREFERRED EMBODIMENTS

In the following description, the invention is illustrated using chicken as the most preferred embodiment. One of ordinary skill in the art would recognize that the invention may be applied to any type of meat including beef, veal, pork, lamb, duck or other animal meat. These meats have the desired consistency so that they can be cut or severed without loss or definition or shape of the cut portions prior to cooking. In fact, the elongated portions remain intact during cooking although they preferably curl or assume other non-linear shapes during cooking. It is also possible to apply this process to fish that has sufficient body to retain its form after being cut as disclosed herein. In certain situations, the cut product can be placed on a support during cooking to assist in retaining its cut form. Suitable supports include pots, pans, cooking sheets or other heatable supports or containers.

Prior to cooking, the finished product can be marinated using various sauces depending on a consumer's taste and preferences. Additionally, the method of the present invention preferably, but not necessarily, includes cooking the food product by any one of baking, broiling, steaming, microwave cooking, grilling, and deep frying. Although any one of these cooking processes may be used, the coated cut product is generally broiled, baked or fried to prepare the final product. Heat can be applied by a grill, convection oven, microwave oven, or heated aqueous medium, such as water or preferably oil. When deep frying in oil is utilized, the coated cut product is cooked in the same manner as a conventional batter coated vegetable or meat product.

In addition to a marinating step, a coat of batter can be and preferably is applied to the final cut product. In addition to the thin coating of batter, the method of the present invention may, but does not necessarily, include applying a layer of breading to the food product. Then, the food product, along with the batter coating and layer of breading, can be further cooked to prepare the food product for consumption.

The method of the present invention includes at least partially cooking the food product. If desired, the fully or partially cooked product may be frozen for distribution to consumers who finish cooking the product at home or re-heat it prior to serving. Accordingly, the food product can be either uncooked, fully cooked, or partially cooked and frozen to allow for shipping to distributors. When partially cooked and frozen food products are received by food service establishments, the food product can be quickly deep fried to both thaw the food product and to complete the cooking process.

If desired, a cavity can be made in the meat and a filling can be deposited in the cavity. Preferred fillings include those that complement the flavor of the meat although the chef or caterer can select any edible material to enhance the consumer's eating experience. Typical fillings include a bread stuffing, a shrimp mixture, a hot dog mixture, a pizza mixture, a cheese filling, a flavorant filling, such as herbs and spices, or a meat mixture. The filling may be uncooked, partially cooked or fully cooked prior to depositing in the cavity of the meat. Depending on the type of filling, it may be preferable to fully cook the filling and partially cook the meat before insertion of the filling into the meat. This allows the meat to be fully cooked with a finish cooking step which results in the warming up of the filling.

Thin coatings of batter and layers of breading are preferably applied to the food product prior to deep frying. For example, a thin layer of batter may be preferably applied along all outer surfaces of the cut meat. After the thin coating of batter is applied, a layer of breading may be placed on the food product. Then, the food product is either fully cooked for immediate consumption or partly or mostly cooked prior to packaging and freezing for transport to a food service establishment for subsequent finish cooking.

It is recognized by those skilled in the art that the present invention can be carried out manually, or by any suitable automatic cutting apparatus, as would be well known to those of skill in the art when considered in combination with this disclosure. Also, the meat may be chilled to facilitate the cutting process.

The present invention achieves unexpected advantages by the novel cutting methods disclosed herein. These methods enable products of desired size portions to be easily achieved. For example, smaller sized portions can be tailored for an individual serving, while larger and more complicated cutting patters can be used on larger sized portions to create products that are intended to be shared by groups of 2, 3, 4, 5, or 6 people or more. This enables the chef or caterer to provide the consumer with a wide variety of menu options.

In addition, the cutting arrangement of the present invention provides east to remove “finger picking” portions which are highly desirable for serving in a social setting where groups of people gather, whether at a n intimate, sit-down dinner or a larger cocktail party where guests are mingling.

More importantly, the present cutting configurations are intended to present novel products that imitate known common shapes, such as those of animals, fish, dinosaurs, flowers, or the like. The invention preferably utilizes non-linear cutting lines to achieve such shapes, thus providing final cooked products that are appealing and desirable to consumers, thus increasing their eating enjoyment. Moreover, when common food materials such as chicken, beef or pork are included in the final product, the consumer is already interested in such products due to their familiarity to and prior acceptance of those types of food.

The drawings illustrate a few different shapes that are preferred for use when the edible material is chicken. These shapes are desirable because they take advantage of the natural shape and configuration of de-boned chicken breasts. Of course, one of ordinary skill in the art would recognize that essentially any type of meat or fish could be pre-portioned to a desired size (i.e., by thickness and weight) or shape to facilitate cutting of the pre-portioned material to the desired final product shape or configuration.

Referring now to the drawing figures, the preferred final chicken products are the “starfish” or “crescent” chicken shown in FIGS. A1 through A7, the “butterfly” chicken shown in FIGS. B1 through B13, and the “calamari” chicken shown in FIGS. C1 through C9. In these figures, the cuts are made by hand using a sharp meat-cutting knife.

To create the crescent chicken, a half chicken breast is used. This portion has a weight of about 4 ounces, and is ideally situated for creating a single or individual serving. As noted above, the desired size can be cut from any larger piece of meat, but the utilization of this material optimizes the utilization of edible material by avoiding the waste of material caused by the cutting or trimming of larger pieces.

The starting breast fillet 10 is illustrated in FIG. A1. The initial thickness is about ½ to ¾″. First a central area of the material is identified by making an indent 15 in the centermost section of the material 10 using three fingers 20 as shown in FIG. A2. The resulting indentation 15 is shown in FIG. A3.

Next a plurality of crescent or curved cuts 25 are made starting at the outer edge of the fillet 10 and directed towards the indent 15. The indent 15 also serves as a location where the cutter can hold the fillet 10 using fingers 20 or a suitable holding tool, such as a rod, fork, or similar object. The exact configuration and length of the curved cut is not critical and can be at the desire of the cutter. For a 4 ounce chicken breast, the overall size is about 9 to 16 square inches, the central portion has a size of around 1 to 2 square inches and the cuts are about 1 to 2″ in length.

The number of cuts is not critical, although for the 4 ounce fillet, it has been found to be advantageous to make around 6 to 12 cuts, thus resulting in around 7 to 13 extensions 30. The cutting steps are illustrated in FIGS. A4 and A5 with the final uncooked crescent chicken portion 35 illustrated in FIG. A6.

It is also possible to instead utilize a plurality of essentially straight radial cuts to create the final uncooked product. It should be understood that hand cutting is not sufficiently accurate to provide entirely straight or precisely evenly spaced cuts, although it is possible to achieve these utilizing automated or semi-automated blades or other cutting devices. Thus, the term “essentially straight” is used to cover the attempts of a user to provide straight radial cuts by hand. Of course, the skilled artisan can readily discern what types of cuts are essentially straight rather than curved. Furthermore, the final uncooked product can include crescent cuts, straight cuts, combinations of straight and curved cuts, cuts that are part straight and part curved, etc., as desired.

The finished cut product 35 then can be cooked according to any known techniques including the typical ones that were previously mentioned. In the present invention, it has been found to be desirable to coat the finished cut product with a batter or bread containing coating of the type used to prepare conventional fried chicken. The precise recipe is of no criticality and would be selectable at the desire of the chef or caterer. Generally, the final cut product can be dipped in egg or batter and then coated with four or breadcrumbs that contain herbs and spices before being immersed in a deep fryer that contains hot vegetable oil. The coated product is cooked for a time sufficient to provide a final cooked product. The skilled artisan is well aware of the appropriate cooking conditions to achieve the final cooked product so that they do not have to be mentioned herein in further detail. When this technique is used, the final product is a fried chicken having a plurality of extensions 40 separated by cuts 45. The final product 50 is illustrated in FIG. A7. Again, the size, shape and configuration of the extensions are not critical and is selectable by the user.

Also, when thicker starting portions are utilized, it is acceptable to provide a center cut through the portions along its outer perimeter but not through the central portion so that reduced thickness upper and lower sections are prepared. Conveniently, the center cut s directed approximately through the center of the thickness of the portion, although this is not critical. In fact, multiple center cuts can be made so that there are 3, 4 or even more sections of material are created. Then, when the crescent or straight cuts are made through the plurality of cut sections, thinner extensions are obtained. Generally, the thinner the extension, the more curliness or non-linearity is imparted to the cooked extensions. This will be illustrated further in additional drawing figures. This teaching demonstrates that the user can form a wide variety of shapes and appearances depending upon the number of cuts, the cut configurations, and the thickness of the extensions. As noted above, animal and flower shapes can easily be achieved to allow, for example, the chef or caterer to design a particular shape to fit the theme of a gathering or party, thus making the final cooked product desirable as well as contributing to the theme and effectiveness of the gathering.

A second shape, this of a butterfly, is illustrated in FIGS. B1 through B13. As this shape is more complex than that of FIGS. A1 through A7, additional steps are required to form it. This illustrates the versatility of the starting material and that the final shapes are limited only by the creativity of the person doing the cutting and cooking, i.e., the chef or caterer. Again, cutting by hand is disclosed but the use of automated cutting equipment can easily be incorporated, especially when more complex cuts and multiple repetitive cutting is required to create the shapes or prepare the desired serving portion size. Often, a food manufacturing company will manufacturer the final product, whether finished with a coating or not, and then supply quantities of these products to a food service establishment, such as a restaurant, an institution, i.e., a school or hospital, or the like.

FIG. B1 illustrates the starting material in the form of a butterflied chicken breast 100. Again, this can be removed from the chicken by deboning and used as is or it can be shaped from a larger portion. In this particular embodiment, the breast 100 is provided with four “wing” members 105, 110, 115, 120 in a somewhat symmetric patters of two (i.e., upper and lower) generally symmetrical sides. These are connected along a center area 125 between the sides. The term “generally symmetrical” is used since the portion has some symmetry but exact or precise symmetry is not required. Of course, machine cutting can improve symmetry, if desired. It is of greater importance that the central area be of sufficient size to connect the sides together so that the final product is integral.

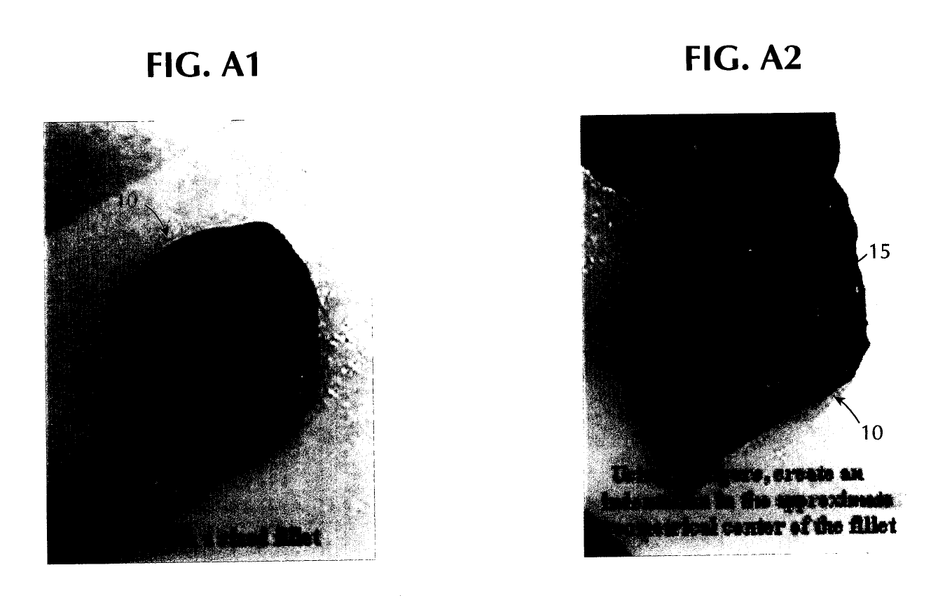

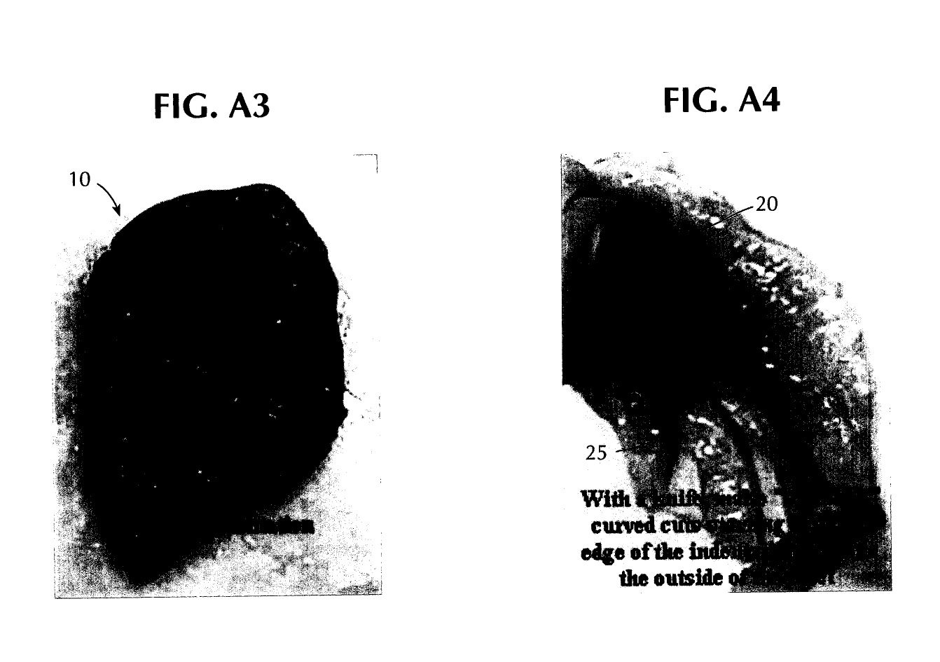

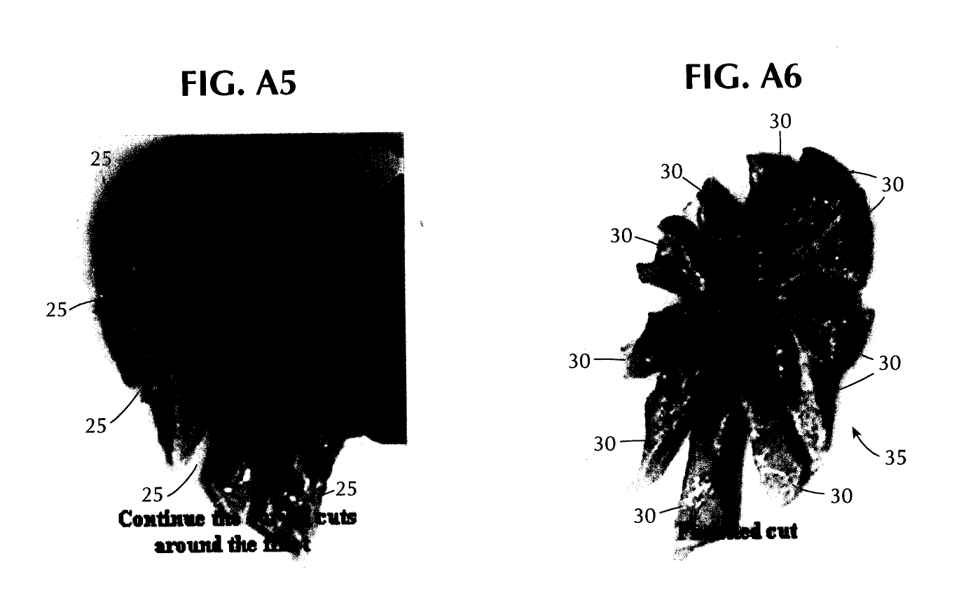

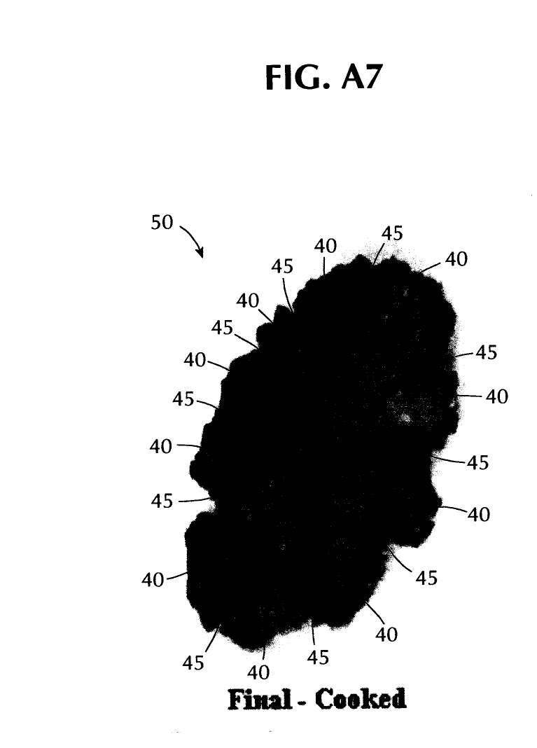

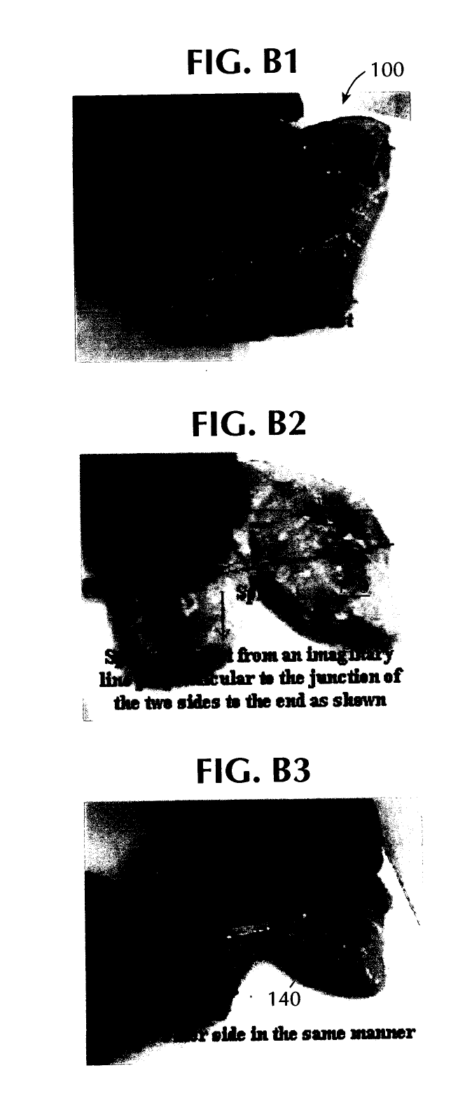

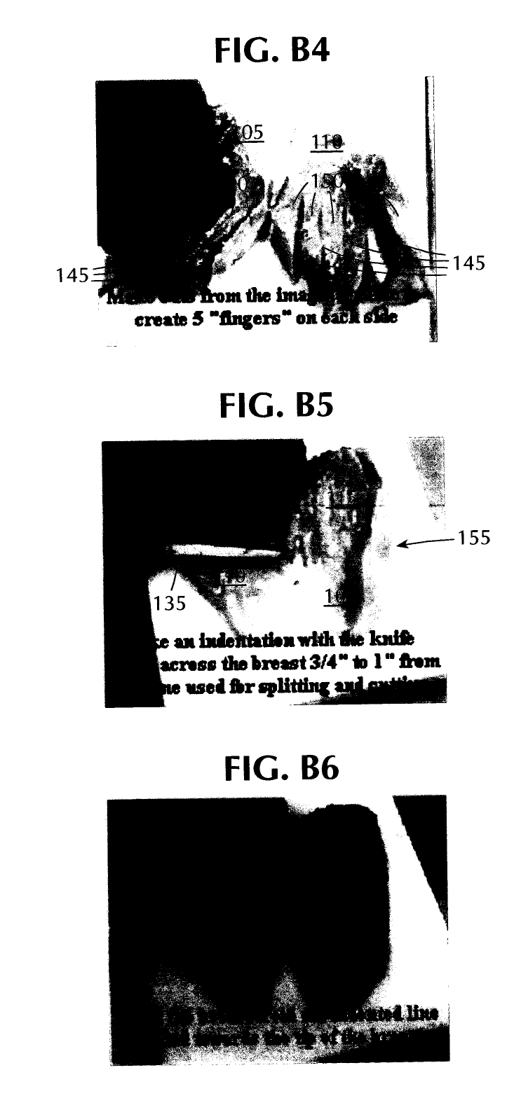

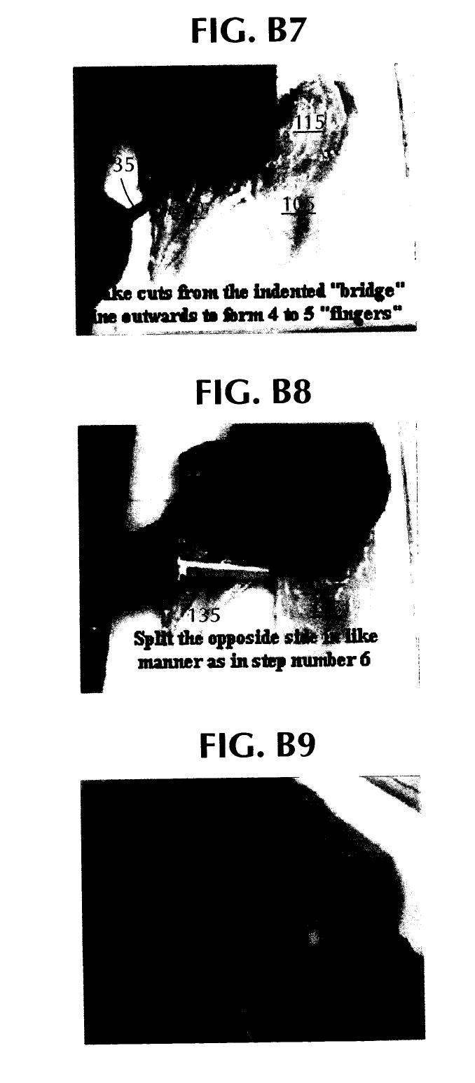

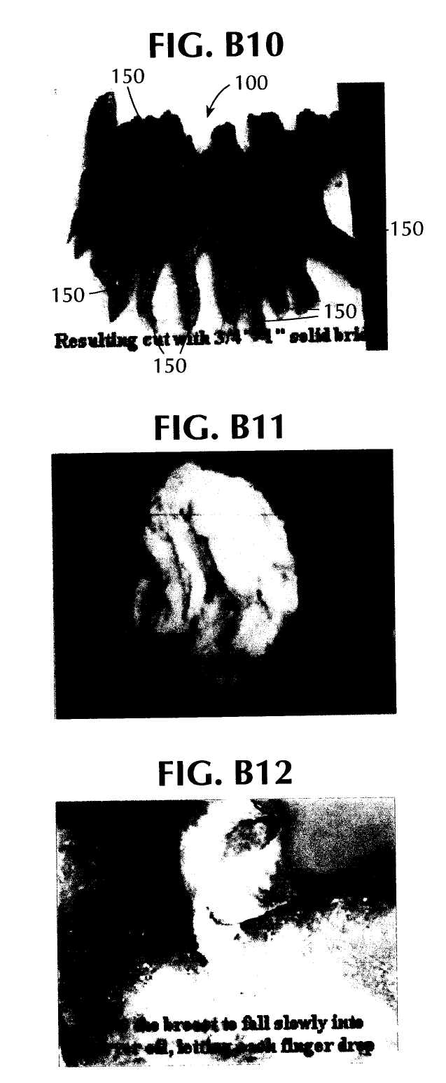

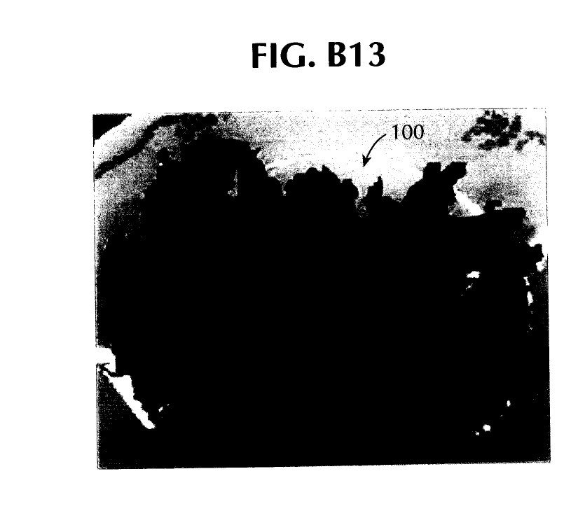

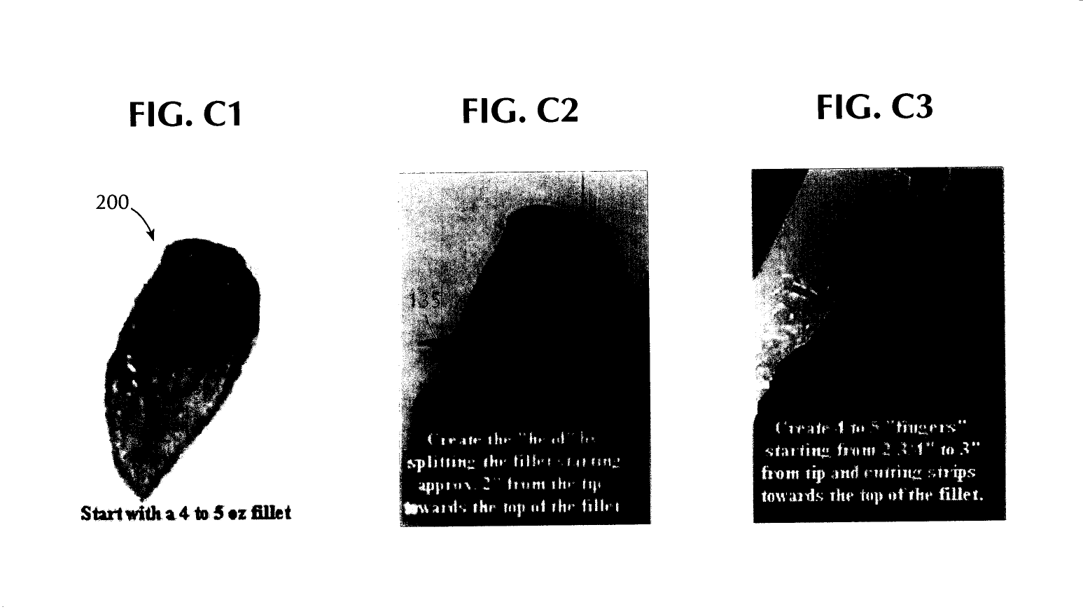

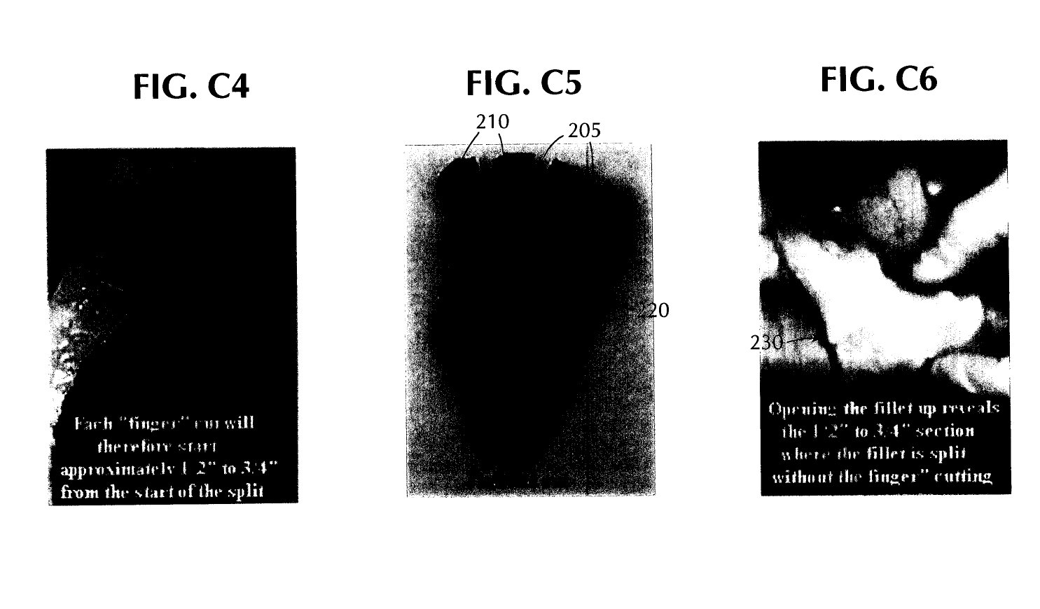

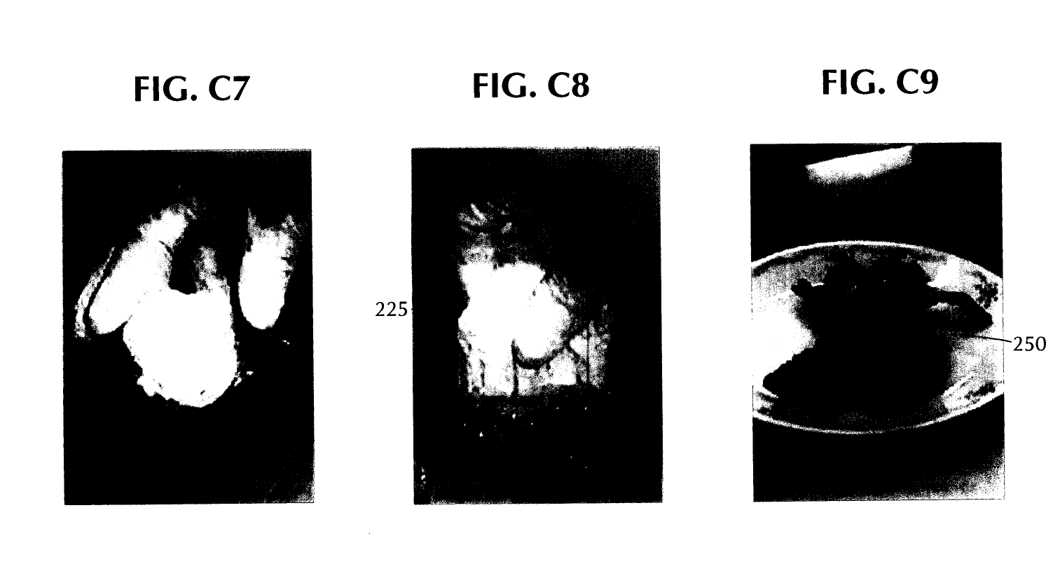

FIG. B2 illustrates an initial step of splitting the thickness of the breast in wing members 115 and 120 along an imaginary line 130 that is perpendicular to the center area 125 that joins the two sides. Wing member 115 is split first as shown in FIG. B2 with wing member FIG. 120 split by cutting, as shown in FIG. B3. As noted above, the thickness of the material can be cut essentially in half or in more layers as desired with the layers being of essentially equal or different thicknesses. For a breast that has a thickness of ¾″ a single split to create two substantially equal thickness portions is entirely satisfactory. FIG. B3 illustrates knife 135 and direction of motion 140 to achieve this split.

FIG. B4 illustrates a plurality of cuts 145 extending from imaginary line 130 to the lower edges of split wing members 115, 120. As shown, four essentially straight cuts are made in each of those wing members to create 10 elongated fingers or extensions on each side, five in each upper section and five in each lower section. As explained above, the cut lines can be straight, curved or in any desired configuration or combination as desired. For ease and simplicity, essentially straight cuts 145 are made.

As described in the previous embodiment, central area 125 is used to hold the wing members together. It is also important to create a space between the cut extensions of wing members 115, 120 and those which are to be provided in wing members 105, 110. This is simply and easily accomplished by making a horizontal indentation 155 generally in alignment with imaginary line 130 adjacent extensions 150 using knife 135 as shown in FIG. B5. For a butterfly breast having a weight of about 8 ounces and a thickness of ½ to ¾″, the indentation 155 should be about ¾ to 1″ wide extending from imaginary line 130. The opposite side of the indentation 155 then indicates where the splitting of wing members 105, 110 can begin. It is immediately recognizable that the breast 100 in FIG. B5 has rotated 180° as the uncut wing members 105, 110 now appear in the lower portion of that figure.

The wing members 105, 110 are then split as shown in FIGS. B6 and B8, and are provided with extensions as shown in FIGS. B7 and B9 by hand using knife 135. These steps would be identical to those of FIGS. B2 through B4 except that the imaginary line to begin the splitting would be located ¾ to 1″ away from the beginning of the cuts in wing members 115, 120 which of course appear as extensions 150. The final product 160 is illustrated in FIG. B10, and it includes 40 extensions, 10 on each wing member, and a horizontal indentation or uncut portion 155.

As explained above, the cooking of this product can be done in many ways, but a preferred way is illustrated in FIGS. B11 and B12. Here, the final cut product is provided with a batter or bread containing coating 165 as shown in FIG. B1, and then is cooked by deep frying in hot oil. FIG. B12 illustrates that the coated uncut portion 155 is used to hold the product with the extensions oriented in a downward direction toward the oil. He extensions are preferably dropped into the oil individually and sequentially to facilitate complete frying of the coating. The uncut portion is then released and cooked to form the final product 175 that is illustrated in FIG. B13. The greater number of cooked extensions of this product, due to the larger starting weight and size of the meat, renders it suitable as a multi-person fried chicken product, where each person can remove one or more extensions for consumption.

FIGS. C1 through C9 illustrate a further preferred embodiment of the invention, in the form of a calamari shape. A four to five ounce portion 200 of chicken filet, preferably one that is cut from the breast, is used as the starting material, as shown in FIG. C1. A head member 225 is created in the lower part of the fillet by splitting the fillet 200 about 2″ from the top of the fillet to the top edge using knife 135. This is illustrated in FIG. C2, and it results in a split tail member 205. Next four to five extensions 2110 are cut into the split tail member. These can be spaced as desired with any type of cut as described above with one significant difference. As shown in FIGS. C4 and C5, this cut does not extend through the entire split portion but instead leaves a split but uncut portion 220 separating the extension 210 from the head member 225. The cutting and configuring steps would be the same as those described above in connection with the detailed description of the other drawing figures.

The split area 220 is illustrated in further detail in FIG. C6, where the extensions in the top and bottom split sections are separated in the final cut but uncooked product 230. The split but uncut area 220 is preferably about ½ to ¾″ wide although this is not critical.

The uncooked product may be cooked in any manner described herein, but preferably is coated and fried as described above in connection with the other preferred embodiments. The coated product 235 is grasped by the coated head 225 so that the extensions are initially placed into the heated oil as shown in FIG. C7. Again, these are placed sequentially for optimum results. The coated head member is then dropped into the oil as shown in FIG. C8. The final cooked product 250 is illustrated in FIG. C9, and shows a different arrangement of extensions than the final cooked product of FIGS. A7 and B13. This further illustrates the versatility of the invention to provide different appearing product depending upon the way the cuts are made.

From the foregoing description, it can be seen that the present invention comprises a new and unique method of producing a food product. The method is quick and easy to utilize and the resulting food product is both appetizing and convenient for the consumer to handle. It will be recognized by those skilled in the art that changes could be made to the above-described embodiments of the present invention without departing from the inventive concepts disclosed herein. It is understood, therefore, that this invention is not limited to the particular embodiments disclosed, but it is intended to cover any modifications that are within the spirit and scope of the present invention as defined by the appended claims.

What is claimed is:

1. A method of making a cooked meat product which comprises:
portioning meat to a selected dimension and thickness to form a raw product which corresponds to a desired serving size;
placing a plurality of spaced cuts through the thickness of the raw meat product and extending from a center portion of the raw meat product to its periphery to form a star-shaped raw meat product having a plurality of extensions;
applying to the raw product a coating material comprising flour to form a coated raw product; and
cooking the coated raw product to form a cooked meat product having a plurality of cooked strips corresponding to the extensions.

2. The method of claim 1 wherein the essentially straight line cuts are made in the raw meat product to form radially-directed extensions.

3. The method of claim 1 wherein curved cuts are made in the raw meat product to form crescent-shaped extensions.

4. The method of claim 1 wherein the coated raw product is fried in oil to form the cooked meat product.

5. The method of claim 1 wherein the cooked strips extend from the center portion in substantially the same plane.

6. The method of claim 1 wherein the thickness of the raw meat product is cut essentially perpendicularly to the spaced cuts to create thinner extensions.

7. The method of claim 1 wherein the meat is chicken and the raw product is a boneless chicken breast.

8. A method of making a cooked meat product which comprises:
portioning meat to a selected dimension and thickness to form a raw meat product that includes a center portion that connects at least one upper portion and at least two lower portions that are not joined, with the raw meat product corresponding to a desired serving size;
placing a plurality of spaced cuts through the thickness of the upper and lower portions extending from the center portion of the raw meat product to its periphery to form a plurality of extensions;
applying to the raw product a coating material comprising flour to form a coated raw product; and
cooking the coated raw product to form a cooked meat product having a plurality of cooked strips corresponding to the extensions.

9. The method of claim 7 wherein the thickness of one or more of the upper and lower portions is cut essentially perpendicularly to the spaced cuts to create thinner extensions.

10. The method of claim 7 wherein the thicknesses of all of the upper and lower portions are cut essentially perpendicularly to the spaced cuts to create thinner extensions.

11. The method of claim 7 wherein the spaced cuts are essentially perpendicular.

12. The method of claim 7 wherein the coated raw product is fried in oil to form the cooked meat product.

13. The method of claim 7 wherein the cooked extensions extend from the center portion but not in the same plane as the center portion.

14. The method of claim 7 wherein the meat is chicken and the raw product is a butterflied chicken breast.

15. A method of making a cooked meat product which comprises:
portioning meat to a selected dimension and thickness to form a raw product which has upper, center and lower portions and which corresponds to a desired serving size;
placing a plurality of spaced cuts through the thickness of one of the lower or upper portions of the raw meat product extending from a center portion of the raw meat product to its upper or lower end to form a plurality of extensions;
applying to the raw product a coating material comprising flour to form a coated raw product; and
cooking the coated raw product to form a cooked meat product having a plurality of cooked strips corresponding to the extensions only in the lower or upper portion.

16. The method of claim 15 wherein the thickness of the center portion and the portion that includes the spaced cuts is cut essentially perpendicularly to the spaced cuts to create two central portions, two cut portions, and thinner extensions.

17. The method of claim 16 wherein the coated raw product is fried in oil to form the cooked meat product having a uncut portion and a split but uncut center portion that has a plurality of extensions.

18. The method of claim 14 wherein the spaced cuts are essentially perpendicular.

19. The method of claim 14 wherein the cooked extensions extend from the center portion but not in the same plane as the center portion.

20. The method of claim 14 wherein the meat is chicken and the raw product is a chicken breast.
